(19) United States
(12) Patent Application Publication
(10) Pub. No.: US 2013/0277477 A1
(43) Pub. Date: Oct. 24, 2013

(54) DUST PROTECTION FOR HPGR

(71) Applicant: Vadim Reznitchenko, Mechanicsburg, PA (US)

(72) Inventor: Vadim Reznitchenko, Mechanicsburg, PA (US)

(73) Assignee: METSO MINERALS INDUSTRIES, INC., Waukesha, WI (US)

(21) Appl. No.: 13/451,903

(22) Filed: Apr. 20, 2012

(51) Int. Cl. B02C 4/28

(52) U.S. Cl. 241/226

(57) ABSTRACT

The invention relates to a roller crusher of the type which comprises a pair of crushing rollers is provided. The crushing rollers are generally parallel to one another and rotate in opposite directions, each roller including a shaft which has end portions, mounted in respective roller bearings. The roller crusher comprises a feeding arrangement for feeding material to be crushed to a crushing zone of the roller crusher. The roller crusher is characterized in that it further comprises a dust protecting enclosure enclosing the crushing zone, the dust protecting enclosure having an inlet opening upstream of the crushing zone and in communication with said feeding arrangement, and an outlet opening downstream of the crushing zone, and in that the roller bearings are arranged outside of the dust protecting enclosure.

### TECHNICAL FIELD

The invention relates to a roller crusher of the type which comprises a pair of crushing rollers, generally parallel to one another and rotating in opposite directions, towards each other, each roller including a shaft which has end portions, mounted in respective roller bearings, and a feeding arrangement for feeding material to be crushed to a crushing zone of said roller crusher.

### BACKGROUND ART

When materials are crushed or pulverised in a roller crusher, two rotatably mounted crushing rollers, separated from each other by a gap, form a draw-in nip where the materials are drawn in, force fed or fed by gravity and crushed or ground between the rolls and against each other in a process which may be called interparticle crushing. Each of the crushing rollers is mounted on a shaft in the roller crusher, which shaft has end portions mounted in respective roller bearings. An advantage of this type of crushing is that an effective crushing may be achieved, even to very small grain sizes, with reduced energy consumption as compared to many other crushing techniques. Further, the level of noise during the process is essentially reduced as compared to other crushing techniques.

During the crushing operation, a large amount of dust is created and naturally spread to the surroundings of the crushing roller. The dust creates a serious problem when it reaches the bearings of the roller crusher, since the operation of the bearings is easily degraded by the dust. In addition, other vital parts of the roller crusher may also be affected by the dust.

Conventional roller crushers solve this problem by adding local protective equipment on the parts that risk being affected by the dust (see, e.g., U.S. Pat. No. 3,833,273). This is a both expensive and time consuming procedure. In addition, the risk of the dust spreading to other adjacent machines and personnel as well as to parts that have not received any protective equipment remains.

### SUMMARY OF THE INVENTION

It is an object of the present invention to provide an improvement of the above technique and prior art. More particularly, it is an object of the present invention to provide an improved roller crusher preventing the spreading of dust.

These and other objects as well as advantages that will be apparent from the following description of the present invention are achieved by a roller crusher according to the following features.

A roller crusher of the type which comprises a pair of crushing rollers is provided. The crushing rollers are generally parallel to one another and rotate in opposite directions, towards each other, each roller including a shaft which has end portions, mounted in respective roller bearings. The roller crusher comprises a feeding arrangement for feeding material to be crushed to a crushing zone of the roller crusher. The roller crusher is characterized in that it further comprises a dust protecting enclosure enclosing the crushing zone, the dust protecting enclosure having an inlet opening upstream of the crushing zone and in communication with said feeding arrangement, and an outlet opening downstream of the crushing zone, and in that the roller bearings are arranged outside of the dust protecting enclosure. This is advantageous in that, since the entire crushing zone is enclosed by the dust protecting enclosure, the dust is completely prevented from spreading to the roller bearings and to other places where it might cause problems. The only way for the dust to move is downwards and out through the outlet opening where no sensitive parts are affected by the dust. Accordingly, no local protective equipment is needed on the roller crusher and the risk of the dust spreading to other adjacent machines and personnel as well as to parts that have not received any protective equipment is eliminated. Another advantage is that the procedure of equipping the crushing zone with such a dust protection enclosure is inexpensive and easily performed in relation to the conventional dust protection procedures.

The crushing rollers may be at least partly enclosed in the dust protecting enclosure or completely enclosed in the dust protecting enclosure depending on which embodiment of the invention is preferred.

The dust protecting enclosure may comprise side walls which are easy and cheap to manufacture and to mount in the roller crusher.

At least one side wall may comprise an inspection window, which is advantageous in that the crushing operation as well as the parts involved can be monitored from the outside at any time. Naturally, the dust protection enclosure may comprise additional inspection windows and inspection doors for monitoring. Also, maintenance doors may be provided in order to facilitate maintenance of the roller crusher.

The side walls may be releasably mounted to the roller crusher or to a foundation on which the roller crusher is arranged. When the crushing rollers or any other parts located within the crushing zone needs maintenance or replacement, easy access will be provided by means of the releasably mounted side walls.

The feeding arrangement may comprise a funnel and may be sealingly connected to the inlet opening, which results in an even more secure area without any leakage of dust.

Generally, all terms used below are to be interpreted according to their ordinary meaning in the technical field, unless explicitly defined otherwise herein. All references to “a/an/the [element, device, component, means, etc]” are to be interpreted openly as referring to at least one instance of said element, device, component, means, etc., unless explicitly stated otherwise.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a perspective view of a roller crusher without a dust protecting enclosure mounted,

FIG. 2 is a perspective view of a roller crusher having a dust protecting enclosure; and

FIG. 3 is a perspective view of an alternative mounting of the dust protecting enclosure.

### DETAILED DESCRIPTION OF PREFERRED EMBODIMENTS OF THE INVENTION

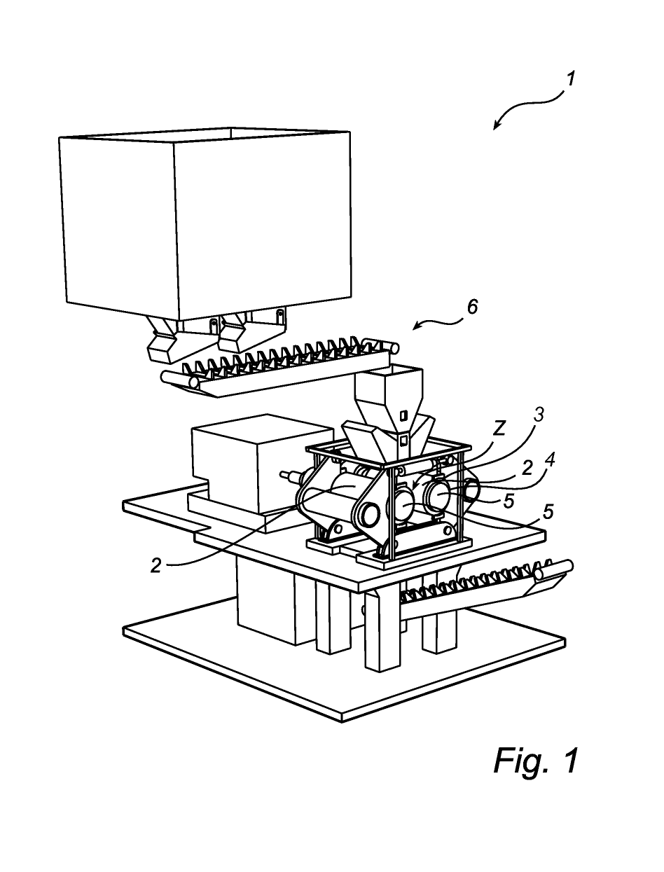

FIG. 1 illustrates a roller crusher 1 having two crushing rollers 2, which are parallel to one another and rotate in opposite directions, towards each other. Each one of the crushing rollers 2 has a shaft 3 with end portions 4 mounted in respective roller bearings 5. The roller crusher 1 has a feeding arrangement 6 for feeding material to be crushed to a crushing zone Z of the roller crusher 1. After the material has been crushed in the crushing zone, it is transported away from the roller crusher.

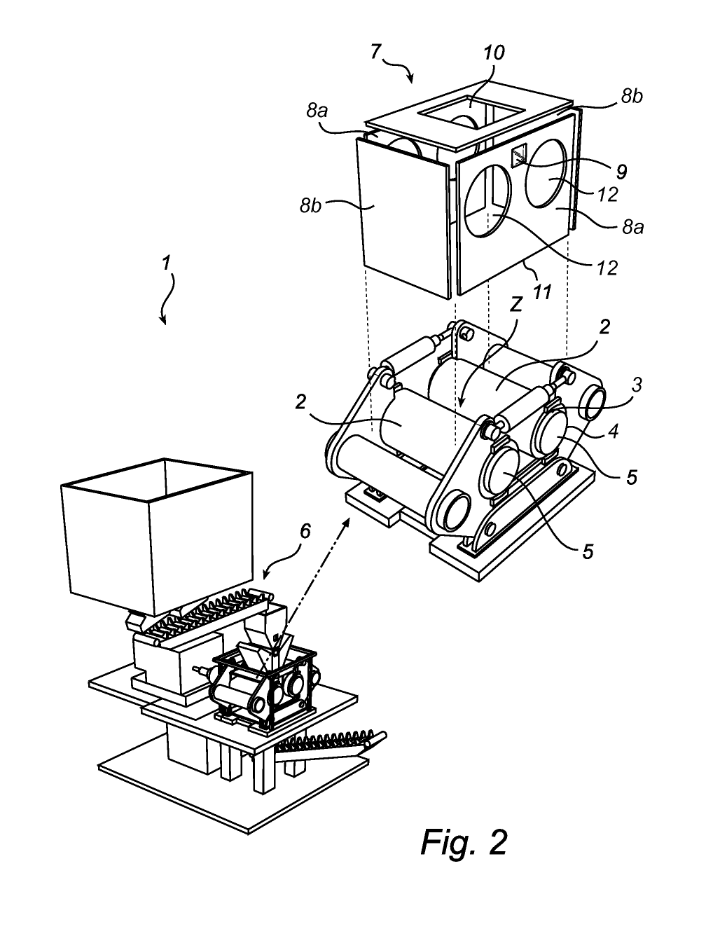

In FIG. 2, the roller crusher 1 of FIG. 1 is illustrated when a dust protecting enclosure is mounted to the roller crusher 1. The dust protecting enclosure 7 has four side walls 8 enclosing the crushing zone Z. Two longer side walls 8a extend in a direction perpendicular to a longitudinal direction of the rollers 2, and two shorter side walls 8b extend in a direction parallel to the longitudinal direction of the rollers 2. One of the longer sidewalls 8a has an inspection window 9 for monitoring from outside of the dust protecting enclosure 7. The side walls 8 are releasably and flexibly mounted to the roller crusher 1 so that when the crushing rollers 2 or any other parts located within the crushing zone Z needs maintenance or replacement, they will be accessible by dismounting one or several of the side walls 8. Due to the fact that the side walls 8 are flexibly attached to the roller crusher 1, the dust protecting enclosure 7 will be less sensitive to vibrations. The dust protecting enclosure 7 has an inlet opening 10 upstream of the crushing zone Z which is in communication with the feeding arrangement 6, and an outlet opening 11 downstream of the crushing zone Z. Further, the dust protecting enclosure 7 has shaft openings 12 through which the shafts 3 extend with their end portions 4. The roller bearings 5 of the roller crusher are arranged outside of the dust protecting enclosure 7 in order to avoid contact with the dust created in the crushing zone Z. In this embodiment, the crushing rollers 2 are completely enclosed within the dust protecting enclosure 7. However, other arrangements are naturally also possible.

The dust protecting enclosure 7 can both be placed in the roller crusher 1 during the manufacture of the roller crusher 1 as well as later on in an already existing roller crusher 1 of the type illustrated in FIG. 1. Due to the fact that the dust protecting enclosure 7 encloses the crushing zone Z of the roller crusher 1, no further dust protection equipment is needed in order to protect the vital parts of the roller crusher 1 from the dust created during the crushing operation of the roller crusher 1. Accordingly, instead of providing local protective equipment on every part of the roller crusher 1 which is affected by the dust, the dust protecting enclosure 7 protects the entire roller crusher 1 from dust. The surroundings of the roller crusher, i.e. personnel and adjacent machinery, are also protected from the dust by means of the dust protecting enclosure 7.

During the crushing operation of the roller crusher 1, the material to be crushed is transported to the feeding arrangement 6 of the roller crusher 1 and introduced in the funnel of the feeding arrangement 6. The material to be crushed then travels by gravity from the feeding arrangement 6 to the crushing zone Z via the inlet opening 10 of the dust protecting enclosure 7, which is completely enclosing the crushing zone Z. When the material has been crushed by means of the two parallel and rotating crushing rollers 2, it travels by gravity out of the crushing zone Z via the outlet opening 11 in order to be transported from the plant.

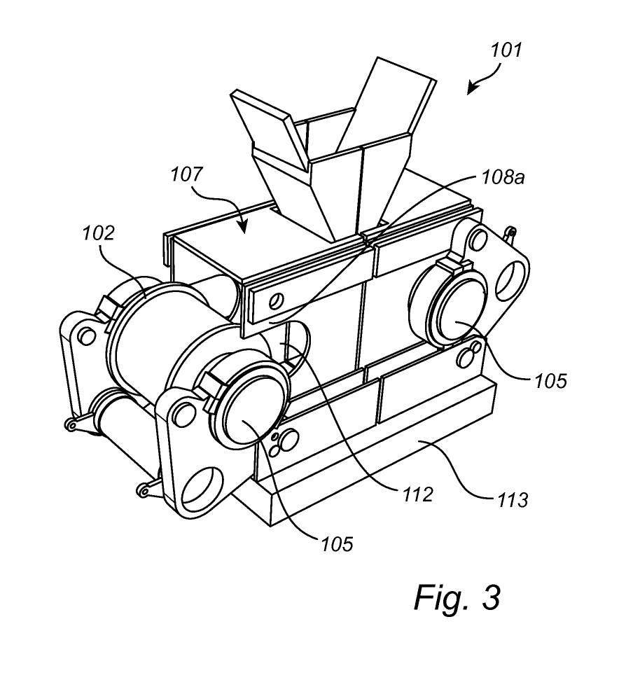

In the embodiment shown in FIGS. 1 and 2, the dust protecting enclosure is mounted to the roller crusher 1. In an alternative embodiment shown in FIG. 3, the dust protecting enclosure 107 is instead mounted to a foundation 113 of the roller crusher 101. In this embodiment, the shaft openings 112 in the longer side walls 8a are not circular, as in FIG. 2, but oval. This is due to the fact that when the dust protecting enclosure 107 is mounted to the foundation 113, the rollers 2 need to be able to be moved outwards, from each other, for maintenance and replacement. In all other respects, the description above in connection with FIGS. 1 and 2 is valid also for the embodiment shown in FIG. 3.

The invention has mainly been described above with reference to a few embodiments. However, as is readily appreciated by a person skilled in the art, other embodiments than the ones disclosed above are equally possible within the scope of the invention, as defined below.

For instance, the dust protecting enclosure need not necessarily enclose the rolls entirely. Instead, the shorter side walls could be arranged approximately at a central axis of the rollers and extend down from the top of the dust protecting enclosure to a level slightly above the crushing surface of the rollers. This would lessen the dust protecting efficiency, since dust could leak out under the shorter side walls. However, this could be compensated for by adding evacuation equipment adjacent the lower edge of the shorter side walls for evacuating dust. Alternatively, the dust protecting efficiency could be improved by adding a flexible skirt made of, e.g. elastomeric material, at the lower edge of the shorter side walls.

The dust protecting enclosure may be equipped with hatches or doors for inspection and/or maintenance of the rollers. These may be arranged in one or more of the side walls and/or in the top wall of the enclosure.

It should be noted that, although the enclosure has been referred to as a dust protecting enclosure, it may also act as a noise reducer, especially if sound insulating material is arranged on the side walls.

1. A roller crusher of the type which comprises
a pair of crushing rollers, generally parallel to one another and rotating in opposite directions, each roller including a shaft which has end portions, mounted in respective roller bearings, and
a feeding arrangement for feeding material to be crushed to a crushing zone of said roller crusher,
wherein said roller crusher further comprises a dust protecting enclosure enclosing said crushing zone, said dust protecting enclosure having an inlet opening upstream of said crushing zone and in communication with said feeding arrangement, and an outlet opening downstream of said crushing zone, and in that said roller bearings are arranged outside of said dust protecting enclosure.

2. A roller crusher according to claim 1, wherein said crushing rollers are at least partly enclosed in said dust protecting enclosure.

3. A roller crusher according to claim 1, wherein said crushing rollers are completely enclosed in said dust protecting enclosure.

4. A roller crusher according to claim 1, wherein said dust protecting enclosure comprises side walls.

5. A roller crusher according to claim 4, wherein at least one of said side walls is flexibly attached to said roller crusher.

6. A roller crusher according to claim 1, wherein said dust protecting enclosure is at least partially flexibly attached to said roller crusher.

7. A roller crusher according to claim 4, wherein at least one side wall comprises an inspection window.

8. A roller crusher according to claim 4, wherein said side walls are releasably mounted to said roller crusher.

9. A roller crusher according to claim 1, wherein said feeding arrangement sealingly connected to said inlet opening.

10. A roller crusher according to claim 1, wherein said feeding arrangement comprises a funnel.
